(19) United States
(12) Patent Application Publication
(10) Pub. No.: US 2009/0063110 A1
(43) Pub. Date: Mar. 5, 2009

(54) Brachytherapy dose computation system and method

(75) Inventors: Gregory Alexander Failla, Gig Harbor, WA (US); Douglas Allen Barnett, Pattersonville, NY (US); John Morton McGhee, Hollis, NH (US); Todd Arlin Wareing, Gig Harbor, WA (US)

Correspondence Address: STEVEN P. KODA;KODA LAW OFFICE, 19689 - 7TH AVE NE, NO. 307, POULSBO, WA, 98370, US

(73) Assignee: Transpire,Inc., Gig Harbor, WA (US)

(21) Appl. No.: 12/290,201

(22) Filed: Oct. 28, 2008

Related U.S. Application Data
(63) Continuation-in-part of application No. 11/726,386, filed on Mar. 21, 2007.
Application No. 11/726,386 is a continuation-in-part of application No. 11/499,862, filed on Aug. 3, 2006, now abandoned.
Application No. 11/499,862 is a continuation-in-part of application No. 11/273,596, filed on Nov. 14, 2005.
Application No. 11/273,596 is a continuation-in-part of application No. 10/910,239, filed on Aug. 2, 2004, now abandoned.
Application No. 10/910,239 is a continuation-in-part of application No. 10/801,506, filed on Mar. 15, 2004, now abandoned.
(60) Provisional application No. 60/454,768, filed on Mar. 14, 2003.
(60) Provisional application No. 60/491,135, filed on Jul. 30, 2003.
(60) Provisional application No. 60/505,643, filed on Sep. 24, 2003.

(51) Int. Cl. G06G 7/48

(52) U.S. Cl. 703/2

(57) ABSTRACT

Brachytherapy dose attributable to a brachytherapy source is computed for portions of a patient treatment volume corresponding to a pathological target volume and critical structures. Patient image data is accessed to derive a material voxel array. Multiple computation grids are derived. Primary particle fluence is computed for each first grid element using a ray tracing process from which a primary dose and a first scattered particle source are derived. Scattered particle fluence of the first scattered particle source is derived for each second grid element from which a secondary dose is derived. Each first grid element corresponds to a plurality of second grid elements. Primary dose and scattered dose combine to provide total dose at specific volumes. Brachytherapy source models and non-anatomical body surface models may be applied as applicable.

### CROSS REFERENCE TO RELATED APPLICATIONS

This application claims the benefit of and is a continuation-in-part of U.S. patent application Ser. No. 11/726,386, filed Mar. 21, 2007 of Failla et al. for “Method for Calculation Radiation Doses From Acquired Image Data”, which is a continuation-in-part of application Ser. No. 11/499,862, filed Aug. 3, 2006, which is a continuation-in-part of application Ser. No. 11/273,596, filed Nov. 14, 2005, which is a continuation-in-part of application Ser. No. 10/910,239, filed Aug. 2, 2004, which is a continuation-in-part of application Ser. No. 10/801,506, filed Mar. 15, 2004, which claims the benefit of provisional Application Nos. 60/454,768, filed Mar. 14, 2003; 60/491,135, filed Jul. 30, 2003; and 60/505,643, filed Sep. 24, 2003.

### FIELD OF THE INVENTION

The present invention generally relates to systems and methods for planning radiotherapy treatments, and more particularly to systems and methods calculating dose and simulating radiation transport for a brachytherapy source.

### BACKGROUND OF THE INVENTION

Radiotherapy (or radiation therapy) is the medical use of ionizing radiation as part of a cancer treatment to control malignant cells, and may be used for curative, adjuvant or palliative cancer treatment purposes. Radiation therapy works by damaging the DNA of cells. The damage is caused by a photon, electron, proton, neutron, or ion beam directly or indirectly ionizing the atoms which make up the DNA chain of the cell. Indirect ionization happens as a result of the ionization of water, forming free radicals, notably hydroxyl radicals, which then damage the DNA. In the most common forms of radiation therapy, most of the radiation effect is through free radicals. Because cells have mechanisms for repairing DNA damage, breaking the DNA on both strands has proven to be a significant technique in modifying cell characteristics. Because cancer cells generally are undifferentiated and stem cell-like, they reproduce more, and have a diminished ability to repair sub-lethal damage compared to most healthy differentiated cells. The DNA damage is inherited through cell division, accumulating damage to the cancer cells, causing them to die or reproduce more slowly.

Brachytherapy, also known as sealed source radiotherapy or endocurietherapy, is a form of radiotherapy where a radioactive source is placed inside or next to an area requiring treatment. Brachytherapy is commonly used to treat localized prostate cancer, cervical cancer and cancers of the head and neck.

Brachytherapy treatment planning is performed to determine an optimal location and dose for one or more brachytherapy sources to be used in treatment. In particular, a brachytherapy source emits radiation. To spare normal tissues (such as organs and tissue which radiation may pass through to expose a tumor), it is desired to determine the effects for different locations and doses of the brachytherapy source. An optimal location provides a desired radiation dose to the target tumor, while ideally providing substantially less absorbed dose to neighboring normal tissues.

Typically, brachytherapy treatment plans are developed in real time, with a physicist interacting with a computer. As a result, speed is an important factor in designing brachytherapy radiation transport simulations. In achieving efficient speeds, accuracy may be compromised. For example, while accurate dose calculation methods, such as Monte Carlo are known, implementation typically is slow. Simpler methods are conventionally used due to time constraints. Accordingly, there is a need for methods of brachytherapy radiation transport simulation and dose calculation which meet both speed and accuracy constraints of the clinical brachytherapy setting. These and other needs are addressed by various embodiments of the present invention.

### SUMMARY OF THE INVENTION

The present invention provides a system, method and software program for computing brachytherapy dose, such as may be performed for brachytherapy treatment planning. A brachytherapy source is modeled as one or more point sources. One or more computation grids are derived. A material voxel array corresponds to at least one of the grids. In one embodiment each brachytherapy source is modeled as a plurality of point sources, and a single computation grid is derived. In another embodiment each brachytherapy source is modeled as one or more point sources, and a multiple computation grids are derived. In still another embodiment each brachytherapy source is modeled as a plurality of point sources, and a multiple computation grids are derived. A computation grid is used for defining elements where dose is computed for treatment area. The material voxel array may correspond to the same treatment area, and represent material properties at voxels corresponding to specific volume units of the treatment area.

In embodiments where first and second grids are derived, the first grid having coordinate elements of a first volume is used to compute primary dose, and the second grid corresponding to the same treatment area, but having coordinate volume elements of a second volume, is used to compute scattered dose.

Ray tracing between a brachytherapy point source and a grid elements is performed to derive angular photon flux. Primary dose, and in some embodiments scattered particle point source, are derived from the angular photon flux. For example, scattered dose may be computed for each second-grid grid element from a corresponding scattered particle point source. Total dose in a target volume within the treatment area is the sum of the primary dose, and for embodiments where scattered dose is calculated scattered dose, for grid elements within the target volume.

In some embodiments, surface models may be applied to account for attenuation effects of non-anatomical bodies positioned at intersected grid elements. In some embodiments, a brachytherapy source may be modeled as a single point source for ray tracing where distance from the brachytherapy source exceeds a threshold distance; and may be modeled as multiple point sources for ray tracing where distance is less than the threshold distance.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a diagram of patient with implanted brachytherapy sources at a target volume;

FIG. 2 is a block diagram of a brachytherapy dose computation and treatment planning system, according to an embodiment of the present invention;

FIG. 3 is a diagram which depicts a voxel array superimposed upon acquired image data;

FIG. 4 is a diagram which depicts first and second computation grids superimposed upon acquired image data;

FIG. 5 is a diagram which depicts a surface model superimposed upon a voxel array;

FIG. 6 is a diagram of a brachytherapy source modeled as a single point source;

FIG. 7 is a diagram of a brachytherapy source modeled as multiple point sources;

FIG. 8 is a diagram of a brachytherapy source, in which each of multiple segments are modeled as a single point source;

FIG. 9 is a diagram of a brachytherapy source implanted within a patient and emitting a photon which incurs collisions while traversing through the patient;

FIG. 10 is a diagram of ray tracing between a point source and a grid element, according to an embodiment of the present invention;

FIG. 11 is a diagram of ray tracing between a point source and a voxel while intersecting a surface model, according to an embodiment of the present invention;

FIG. 12 is a diagram of ray tracing between a point source and a voxel while intersecting a surface model of another brachytherapy source, according to an embodiment of the present invention;

FIG. 13 is a flow chart of pre-computation processing, according to an embodiment of the present invention;

FIG. 14 is a flow chart of a dose computation method, according to an embodiment of the present invention; and

FIG. 15 is a flow chart of a brachytherapy treatment planning method, according to an embodiment of the present invention.

### DETAILED DESCRIPTION OF ILLUSTRATIVE EMBODIMENTS

In the following description, for purposes of explanation and not limitation, specific details are set forth in order to provide a thorough understanding of the present invention. However, it will be apparent to one skilled in the art that the present invention may be practiced in other embodiments that depart from these specific details.

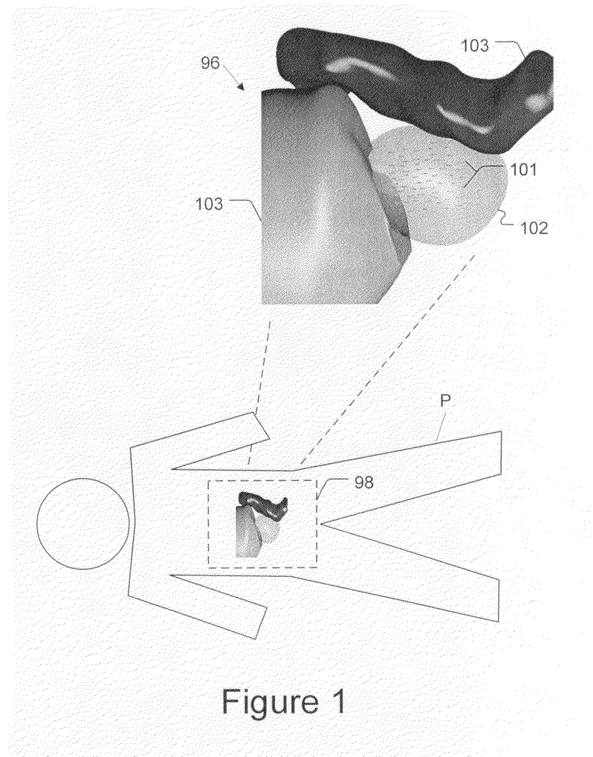

FIG. 1 shows a patient P undergoing brachytherapy, in which localized radiation sources 101 are placed inside, or in close proximity to a target volume 102 (e.g., tumor, malignant cells, other pathological tissue). Ideally, the sources 101 are arranged to maximize dose to the target volume 102, while minimizing dose to neighboring regions, such as critical structures 103. For purposes of description, the following terminology is used herein. The imaged area 96 corresponds to the volume within the patient P from which image data is acquired. The treatment area 98, also referred to herein as a treatment volume, corresponds to the volume within the patient P that may be exposed to radiation, or to a significant amount of radiation. Analysis may be limited to that portion of the treatment area within the imaged area 96. The target volume 102 corresponds to that portion of the patient P having a pathological structure, such as a tumor, that is to be treated with a desired dose of radiation from brachytherapy sources 101. The non-targeted treatment area is that portion of the treatment area, excluding the target volume 101. Surrounding tissue including critical anatomical structures may be included within the nontargeted treatment area. A treatment site is the location where brachytherapy sources are positioned, such as within or near the target volume.

Typically, photon-emitting sources are used as the radiation sources, where source energies are low enough that the spatial transport of secondary electrons may be neglected. For explanatory purposes, photons are commonly referenced as the particle type, though other particle types may be employed, such as electrons, protons or neutrons, while practicing the inventions described herein.

The inventions described herein may be practiced for various types of brachytherapy, such as interstitial brachytherapy, intracavitary brachytherapy, and intravascular brachytherapy. Interstitial brachytherapy is performed by placing radiation sources, such as iridium-192 wire or iodine-125 seeds, into tissue. Intracavitary brachytherapy is performed by placing one or more radiation sources into a pre-existing body cavity. Intravascular brachytherapy is performed by placing a catheter inside a patient's vasculature, then delivering and later removing the radiation source via the catheter. The inventions may be practiced for still other types of brachytherapy, such as mold brachytherapy and strontium plaque brachytherapy for treating superficial tumors and skin lesions. Still another type of brachytherapy for which the inventions may be applied is electronic brachytherapy where no radioactive core is present, and Bremsstrahlung photons are generated electronically during treatment. Electronic brachytherapy involves the placement of a miniature low energy (<50 kVp) x-ray tube source into a pre-positioned applicator within a body cavity or a tumor to rapidly deliver high doses to local target tissues while maintaining low doses to non-local non-target tissues.

Different dosing protocols may be implemented, such as a low dose rate (LDR) protocol where a radioactive source is temporarily or permanently implanted into a patient at a treatment site. A high dose rate (HDR) protocol uses a high dose rate source, such as iridium-192, and has a dose of 20 cGy per minute or higher. A pulsed dosage rate (PDR) protocol is a type of high dosage rate protocol. LDR, HDR, and PDR protocols may be supported according to embodiments of the present invention.

Brachytherapy can be applied manually, or remotely using machines. To spare treatment providers from being exposed to excessive levels of radiation, remote afterloading techniques may be used to deliver the radioactive sources via hollow tubes.

In clinical practice the brachytherapy dose delivered to the target volume 102 typically is calculated using protocols recommended by Task Group 43 from the American Association of Physicists in Medicine (i.e., TG-43 and TG-43U1, respectively). Both of these protocols are based on results for brachytherapy sources that are less than 1.0 cm in length, and assume the sources are situated in a finite homogeneous water medium. A shortcoming of these approaches is that the assumption of a finite homogeneous water medium neglects the effects of patient heterogeneities, such as those resulting from lung, bone, soft tissue, and air. Another shortcoming of these protocols, in implant brachytherapy treatments, is that the close proximity of seeds (i.e., radiation sources) can result in dose perturbations from inter-source attenuation. In other treatments, such as in high dose rate (HDR) or pulsed dose rate (PDR) brachytherapy, the presence of applicators or shields may also substantially influence and alter the dose field.

According to various embodiments of the present invention, a system and method are provided for simulating radiation transport from one or more brachytherapy sources. Each brachytherapy radiation source may be modeled as one or more point sources. The photon fluence for each point source is traced (e.g., ray tracing) through a region which may have heterogeneous qualities. Thus, the ray tracing methods for calculating radiation transport described herein improve upon the conventional TG-43 and TG-43U1 radiation transport formulations at least in part by accounting for patient tissue heterogeneities; the presence of shields and applicators within areas being exposed; and ray tracing between specific volumetric elements and the point sources.

To account for patient tissue heterogeneities, imaging of the treated regions and surrounding anatomy is obtained and analyzed. For example, imaging data in a DICOM format may be received. A material voxel array is generated using the imaging data. Each voxel corresponds to a volumetric unit, and corresponds to one or more pixels of the patient image data. A position of the voxel corresponds to a volume within the treatment area 98 (and also within the imaged area 98). Data stored for a voxel provides an indication of material properties at such location. For example, tissue density, water volume, and other material properties may be associated with each voxel.

According to embodiments of the present invention, one or more computation grids also may be derived. For example, a first grid having elements of a first volume may be used for calculating primary dose, while a second grid corresponding to the same treatment volume but having elements of a second volume different than the first volume, may be used for computing scattered dose. An advantage of using grid elements of a first size for primary dose computation and grid elements of a larger second size for scattered dose computations is that dose computation speeds may be significantly improved, while retaining accuracy. In some embodiments, the first grid and the voxel array have a one to one correspondence of component elements. In an alternative embodiment one gird is derived for use in both primary dose and secondary dose calculations.

For each first-grid element within the target volume 102, or for each grid element within any portion of a treatment volume 98, ray tracing is performed between the first grid element and each radiation point source. The primary component of radiation transport then is derived for each ray trace. When a shield, applicator or another brachytherapy source is in place to block or dampen the radiation, the radiation transport computation performed for a first grid element in the blocked area accounts for such attenuation. Similarly, secondary radiation transport due to scattering is derived for each second grid element by identifying the scattering points and deriving scattering photon fluence.

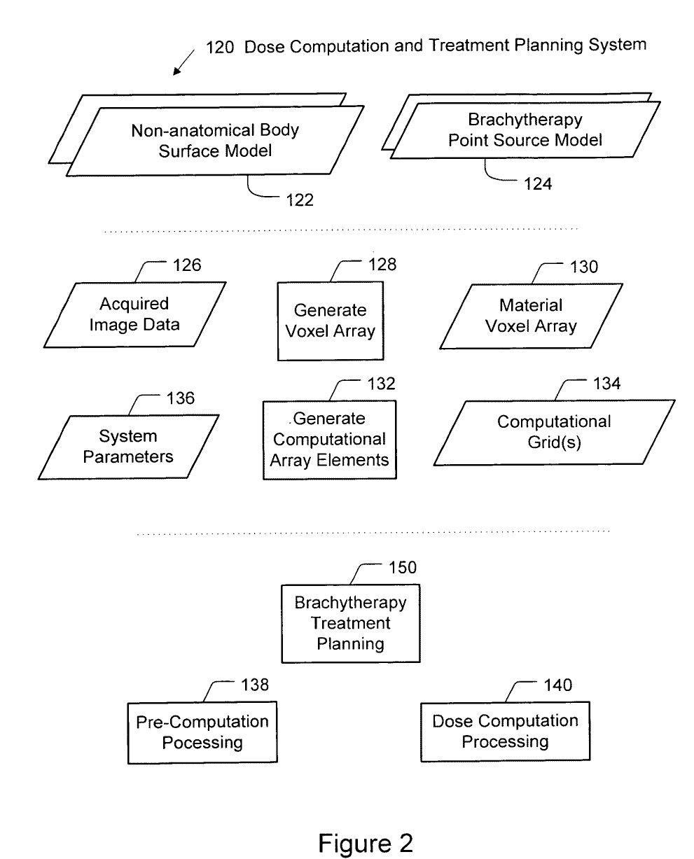

FIG. 2 shows a brachytherapy dose computation and treatment planning system 120, according to an embodiment of the present invention. The system may be implemented by a computer system having a processor and memory, such as a general purpose computer, an embedded computer that is part of a radiation treatment delivery system, or other computing system. The system 120 includes various data structures, including surface models 122 and brachytherapy point source models 124. A surface model 122 may be generated and stored in memory for each of multiple non-anatomical bodies that may be present in the exposure area 98 during treatment. For example, surface models may be developed and stored for various brachytherapy sources 101 and brachytherapy source applicators. In addition, surface models may be developed and stored for various shielding devices used for protecting critical structures 103 of a patient so as to limit radiation exposure behind such shields. Brachytherapy point source 124 models may be generated and stored so as to represent a given brachytherapy source 101 as one or more radiation point sources. Accordingly, there are surface models 122 and point source models 124.

The system 120 is capable of accessing acquired image data 126, such as data in DICOM format obtained using any of various known medical imaging techniques. A process 128 is performed to generate the material voxel array 130 from the acquired image data 126. The voxel array 130 includes a 3-dimensional array of voxels, in which each voxel corresponds to a discrete volume within the patient. Material properties are identified for each voxel. All the voxels of the voxel array may correspond to all or a portion of the treatment area 98.

A process 132 may be executed for generating one or more computation grids 134 which correspond to the same volume as represented by the voxel array 130. Each computation grid 134 may be formed by an array of grid elements, such as Cartesian coordinate elements. In some embodiments, a first grid has a one to one correspondence with the material voxel array, (i.e., for every voxel there is a corresponding one and only one grid element), in effect being a material voxel grid. In various embodiments elements of a first grid have the same, larger, or smaller volume than elements of a second grid. Within a given grid, every element has the same volume.

A set of system parameters 136 also may be included. For example, a threshold distance parameter may be set that may be used for selecting an appropriate brachytherapy point source model during dose computations. Also included may be conversion parameters used for converting acquired image pixel data into density and material property data associated with voxels or the material voxel array 130.

The system 120 also includes software embodying a pre-computation process 138, a dose computation process 140, and a brachytherapy treatment planning process 150. In some embodiments the system 120 may be configured to perform dose computation for a given configuration of brachytherapy sources. For such system configuration, the pre-computation process 138 is executed to set up the various data structures that may be used when subsequently executing the dose computation process 140. The dose computation process computes radiation dose for each grid element of a select treatment volume. The treatment volume may be selected to correspond to a specific volume, such as the target volume 102, or a portion thereof, and/or neighboring structures and critical anatomical structures of concern in the non-targeted area. In other system configurations, the system 120 may be used for brachytherapy treatment planning. For example, the brachytherapy treatment planning process 150 may be implemented with calls to the dose computation process to compute brachytherapy dose at the selected treatment volume for each of multiple brachytherapy source configurations. For example, the types, positions, and numbers of brachytherapy sources to be used to treat a patient may be varied and tested to identify a most effective brachytherapy source configuration that achieves desired treatment at the target volume 102, while minimizing radiation to safe levels at critical structures 103 and surrounding tissue.

Accordingly, the system 120 includes software elements formed by data structures and instruction modules executed as one or more computer programs on a computing system. The software may access inputs including patient image data, and may generate outputs including primary dose, scattered dose and total dose for treatment volumes, anatomical structures, or unit volumes. Further, system parameters may be selected or prescribed, and may, for example, be set by a physicist, technician or other operator.

Following are descriptions of the material voxel array 130, computational grids 134, non-anatomical body surface models 122, brachytherapy source models 124, radiation transport computations, and ray tracing methods used in embodiments of the present invention. Thereafter follow descriptions of a method for computing brachytherapy dose and a method for brachytherapy treatment planning, according to embodiments of the present invention.

### Material Voxel Array

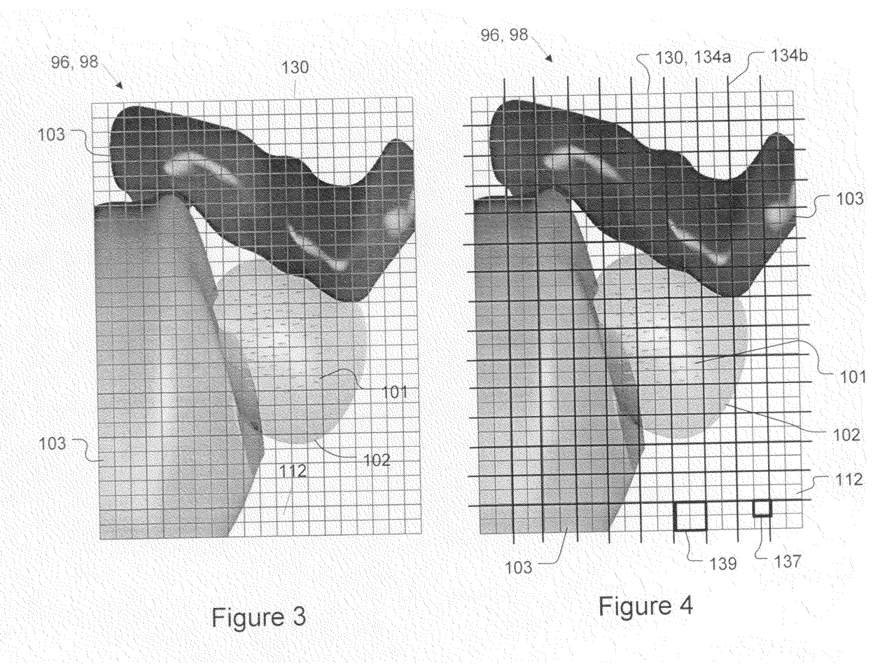

Brachytherapy dose may be calculated for various anatomical structures and areas of interest within a patient. For example, brachytherapy dose may be calculated for various portions of a tumor being treated, and for surrounding structures. FIG. 3 shows a pathological target volume 102, (e.g., a tumor) and nearby critical structures 103 of a patient. Localized brachytherapy radiation sources 101 are placed inside, or in close proximity to the target volume 102. The target volume 102 and the surrounding non-targeted volume (e.g., critical structures 103) within the treatment area may be analyzed to a desired precision to calculate dose at specific sub-volumes. To do so, the treatment exposure area 98 or a portion thereof (e.g., portion for which image data is acquired) may be represented as a set of voxels 112 forming a voxel array 130. Although the voxel array 130 and areas 102, 103 are illustrated in 2-dimensinal format in FIG. 3, the voxel array and areas 102, 103 correspond to three dimensional volumes. Further, although the granularity of the voxel array 130 is shown with voxels 112 being of a relatively large size compared to the areas 102, 103 and brachytherapy sources 101, the voxel dimensions may have a substantially finer granularity. Also, although the voxel array 130 is shown to have a uniform geometric layout, the array 130 may be more closely fit to the one or more structures of interest. Further an array may be defined for each structure, such as for the threes structures depicted, with the three arrays together forming the voxel array of interest.

The voxel array 130 may be derived from imaging data such as DICOM formatted image data obtained used various known medical imaging techniques, such as volumetric computed tomography, positron emission tomography, emission computed tomography, and single photon emission computed tomography. The granularity of the voxel array 130 may be as fine as that of the DICOM image, wherein each voxel corresponds to one pixel of image data. According to embodiments of the invention, a coarser granularity may be used herein to achieve desired computation speeds and desired dose calculation accuracy. For example, each voxel of the voxel array may correspond to an n×n×n pixel volume. The value of n may vary according to the embodiment, and according to a desired granularity. Alternatively, a voxel may be formed by a region of n×m×k pixels where two or more of n, m and k differ. In a specific embodiment, each voxel may have the dimensions 2×2×2 mm³.

The obtained image pixel data is converted to material property data (e.g., tissue density, water volume) using known methods. The material properties for each image pixel within a given voxel then are averaged to define a voxel having homogeneous material properties. Such step is repeated for each voxel. Thus, each voxel 112 in the voxel array 130 has homoegeneous material properties. Note, however, that the material properties of one voxel may differ from other voxels, including neighboring voxels. Accordingly, each voxel is uniquely defined to correspond to the material properties of the patient volume it represents. In a specific method for defining a homogenous voxel, the total interaction cross section, σₜ( r̅), varies with position, while its volume averaged (i.e.: homogenized) value can be expressed as

$${σ}_{t} = \frac{{\int }_{Δ V} d V {σ}_{t} ( \overline{r} )}{{\int }_{Δ V} d V} ,$$

where ΔV is the volume over which the material property is to be homogenized.

### Computation Grids

Computation grids 134 may be defined for purposes of computing dose to specific volume units. A first grid may define a volume unit to be one size, while a second grid may define a volume unit to be another size. A given grid may have a uniform layout with elements corresponding to grid coordinates. A given element corresponds to a given 3-dimensinal coordinate and has a unit volume of a given size. When calculating a dose to be absorbed by an anatomical structure within a treatment volume, the dose may be computed for each element of a computation grid 134 corresponding to the location of the anatomical structure. A grid having elements of one size may be used to compute primary dose, while a grid having elements of a second size may be used for computing secondary dose. Alternatively, one grid may be derived for use in computing both primary dose and secondary dose.

FIG. 4 shows the same treatment volume 98 and imaged area 96 in the patient P as FIG. 3 with first and second computation grids 134a,b overlaid. A first grid 134a includes elements 137 having a first volume. A second grid 134b includes elements 139 having a second volume. In the illustrated embodiment each first grid element 137 is the same size as a corresponding voxel 112 of the voxel array 130, while a second grid element 139 has a larger volume corresponding to eight voxels 112. The specific scaling relationships between the voxel array, first grid, and second grid may vary. In particular, the volume of each element 137 of the first grid 134a may be the same, larger, or smaller than the volume corresponding to a voxel. The volume of each element 139 of the second grid 134b may be the same, larger or smaller than the volume corresponding to a voxel. The volume of each element 139 of the second grid 134b may be the same, larger, or smaller than each element 137 of the first grid 134a.

### Surface Models

When performing brachytherapy, there may be applicators, shields, other brachytherapy sources and other non-anatomical bodies present in the vicinity of a given brachytherapy source. For example, brachytherapy sources may be inserted or otherwise positioned using applicators. Also, to protect critical anatomical structures from unsafe levels of radiation a shield may be placed between the brachytherapy sources and a critical structure 103 of concern. Further in some embodiments, many brachytherapy “seeds” may be inserted into a treatment area.

Imaging data obtained during patient imaging may not provide sufficient information to accurately determine the material properties of the non-anatomical bodies. For example, computed tomography results may be too coarse to accurately describe non-anatomical bodies. Additionally, the presence of high Z materials such as steel, tungsten, or lead may produce image artifacts which further reduce the accuracy in which these bodies are represented in the acquired image. Accordingly, surface models for various non-anatomical bodies 122 may be developed and stored in memory. When a given non-anatomical body is present for a brachytherapy treatment, the corresponding surface model may be accessed to provide material properties and to model any dose perturbing effects.

In particular, a separate surface model may be constructed for each applicator, shield or source manifold body, where each surface model represents the volume of the manifold body. The surface model may consist of a variety of formats, which are familiar to those skilled in the art. These surface models may be created for each relevant applicator, shield and source prior to dose calculations, and stored in computer memory or on disk. Prior to a dose calculation, each applicable surface model may be translated into the correct position and orientation.

There is an exception where the surface model may be suppressed. When calculating dose for a given brachytherapy source, the surface model for such source may be suppressed. Instead the qualities are inherently included in the radiation properties of the point source(s) modeled for such brachytherapy source.

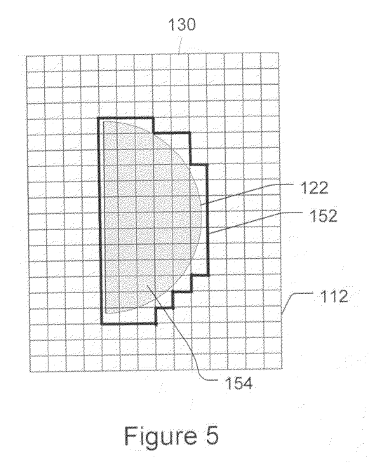

FIG. 5 shows a surface model 122 positioned within a voxel array 130. In some embodiments, an image number, such as a Hounsfield number, may be assigned to each voxel 112 in the voxel array 130, where a conversion relationship is employed to translate the Hounsfield number into a specific material type and density. The enclosed area 152 encompasses all the voxels 154 that have any portion of the surface model 122 within the voxel boundaries. When a portion of the surface model 122 is present at a voxel 112, the image number for that voxel may be altered so as to describe the material properties based at least in part upon the surface model of such applicator or shield, rather than upon the obtained image data. More specifically, homogenization of the material properties is derived according to equations as described above. Some portion of the voxel 112 may correspond to the surface model, while another portion corresponds to patient tissue. The resulting voxel is represented with material properties that are an average for that volume to better represent the attenuation effects of the shield, applicator, source or other non-anatomical body.

### Brachytherapy Source Modeling

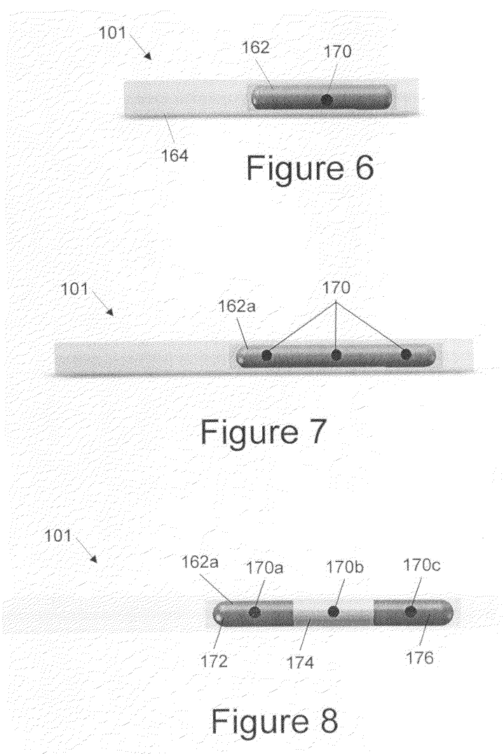

Referring to FIG. 6, an exemplary brachytherapy source 101 may include a radioactive core 162 and a source wire 164 or cladding. The source 101 may be modeled as a point source 170 located at the centroid of the radioactive core 162. The point source 170 may represented as anisotropic in angle and energy, and represent the photon fluence exiting the surface of the brachytherapy source 101.

Referring to FIG. 7, brachytherapy sources with elongated radioactive cores 162a may be represented by a plurality of photon point sources 170 positioned along the radioactive core length. In one embodiment, each point source 170 may represent the photon fluence exiting the brachytherapy source 101 from photons originating from a subset of the complete radioactive core 162a. For example, referring to FIG. 8, a first point source 170a may be located at the centroid of a first radioactive core segment 172, a second point source 170b may be located at the centroid of a second radioactive core segment 174, and a third point source 170c may be located at the centroid of a third radioactive core segment 176. The first point source 170a may represent the photon fluence exiting the brachytherapy source from photons originating in the first radioactive core segment 172. The second point source 170b may represent the photon fluence exiting the brachytherapy source from photons originating in the second radioactive core segment 174. The third point source 170c may represent the photon fluence exiting the brachytherapy source from photons originating in the third radioactive core segment 176.

Each of the point sources 170 may be computed by calculating, through experiment or either a deterministic or stochastic solution method, the photon fluence exiting the brachytherapy source at a corresponding radioactive core section of the brachytherapy source. For example, a first point source 170a may be computed by performing a calculation where a volumetric photon source, having the energy dependent photon spectrum of the radioactive core material, is prescribed in a first radioactive core segment 172. When deriving the first point source, the correct radioactive core material properties may be applied to each of three core segments 172, 174, 176, while ignoring any photon source to be modeled at the second 174 and third 176 radioactive core segments. An output of the first point source calculation is the photon fluence exiting the brachytherapy source surface, which may be binned up in both angle and energy in the resulting point source. Similar calculations are performed to derive the other point sources. Collectively, calculations for each of the point sources 170a,b,c represent the angular and energy dependent photon fluence exiting the brachytherapy source from the entire radioactive core.

The point source(s) 170 only need to be generated once for each unique brachytherapy source make and model. The models for the sources 101 may be stored in computer memory or on disk to be used for subsequent patient specific dose calculations. When a dose calculation is to be performed, the brachytherapy source positions, orientations, and dwell times may be specified as inputs.

In some embodiments one or more threshold distances may be defined for determining the point sources to be derived for a given brachytherapy source 101. For example, the brachytherapy source may be modeled as a single point source for purposes of calculating dose of voxels, or elements, located at distances greater than a first threshold distance. The same brachytherapy source may be modeled as a multiple point source for purposes of calculating dose of voxels, or elements, located at distances less than the first threshold distance. In various embodiments one, two or more threshold distances may be defined for modeling the brachytherapy source as differing numbers of point sources. At distances closest to the brachytherapy source, the highest number of point sources may be used, while at the farthest distances the fewest number of point sources may be used.

The threshold distance(s) may be defined empirically, and in some embodiments may be prescribed, while in other embodiments the distance may be set by an operator. In some embodiments, differing threshold distances may be used according to the material properties of volumes through which the ray is being traced. For example, a first threshold distance may be defined for deciding whether to model a brachytherapy source as one point source or multiple point sources when a ray tracing path intersects anatomical tissue. When a surface model is intersected, a different threshold distance, typically longer, may be used to determine whether to model the brachytherapy source as one point source or multiple point sources. The different threshold distance may vary depending on the specific surface model. A surface model representing large attenuation impacts is associated with a larger threshold distance than a surface model of lower attenuation impact.

### Radiation Transport Computations

To calculate the radiation dose at any point of interest, a steady state solution to the Boltzmann transport equation is obtained at such point for each brachytherapy point source. The Boltzmann transport equation describes the flow of radiation, including photons and electrons through a medium. For most brachytherapy applications photon energies are generally low enough so that the spatial transport of electrons can be neglected, and the electron dose can be approximated through a KERMA reaction rate using an energy dependent photon flux. Following is a discussion of the radiation transport computations implemented in specific embodiments of this invention.

For a problem spatial domain with volume, V, and surface, δV, a time-independent, three-dimensional linear Boltznamm transport equation may be solved, as given by (for brevity the dependent variables have been suppressed in the equations):

\hat{Ω}·\vec{∇}Ψ^{γ}+σₜ^{γ}Ψ^{γ}=q^{γγ}+q^{γ}, (2)

where,

\hat{Ω}·\vec{∇}Ψ^{γ} is the streaming operator;

σₜ^{γ}Ψ^{γ} is the collision or removal operator;

q^{γγ} is the photon source resulting from photon interactions; and

q^{γ} is the fixed or extraneous source.

Equation (2) is subject to all possible standard boundary conditions on δV, the most likely being the vacuum or non-reentrant boundary condition given by:

Ψ^{γ}=0, for \hat{Ω}·\vec{n}<0, (3)

Here Ψ^{γ} more fully represented as Ψ^{γ}(\vec{r},E,\hat{Ω}) is the photon angular fluence, where \vec{r}=(x,y,z) is the spatial position vector, E is energy, \hat{Ω}=(μ,η,ξ) is the unit direction vector, and n is the outward directed unit normal vector to surface δV. Ψ^{γ}(\vec{r},E,\hat{Ω}) may also represent the photon angular flux, but is referred to herein as the photon angular fluence, which is the time integrated flux, since fluence is more commonly referenced in dose calculations.

For Equation (2), \vec{r}εV, \hat{Ω}ε4π, and E>0. In the second term on the left hand side of Equation (2) σₜ^{γ}(\vec{r},E) is the macroscopic photon total cross section. The first term on the right, the scattering source, is defined as:

$${q}^{γγ} ( \vec{r} , E , \hat{Ω} ) = {\int }_{0}^{∞} d {E}^{′} {\int }_{4 π} d {Ω}^{′} {σ}_{s}^{γγ} ( \vec{r} , {E}^{′} \to E , \hat{Ω} \cdot {\hat{Ω}}^{′} ) {Ψ}^{γ} ( \vec{r} , {E}^{′} , {\hat{Ω}}^{′} ) ,$$

where, q^{γγ} is the photon source resulting from photon interactions and σₛ^{γγ} is the macroscopic photon-to-photon differential scattering cross section.

The macroscopic differential scattering cross section may be expanded into Legendre polynomials, Pₗ(μ₀), where μ₀=\hat{Ω}·\hat{Ω}′. This expansion allows the differential scattering or production cross section(s) to be expressed as:

$${σ}_{s}^{γγ} ( \vec{r} , {E}^{′} \to E , \hat{Ω} \cdot {\hat{Ω}}^{′} ) = {\sum }_{l = 0}^{∞} \frac{2 l + 1}{4 π} {σ}_{s , l}^{γγ} ( \vec{r} , {E}^{′} \to E ) {P}_{l} ( {μ}_{0} ) . \qquad ( 5 )$$

Similarly, the angular fluence appearing in the scattering source may be expanded into spherical harmonics moments:

$${Ψ}^{γ} ( \vec{r} , {E}^{′} , {\hat{Ω}}^{′} ) = {\sum }_{l = 0}^{∞} {\sum }_{m = - l}^{l} {φ}_{l , m}^{γ} ( \vec{r} , {E}^{′} ) {Y}_{l , m} ( {\hat{Ω}}^{′} ) , \qquad ( 6 )$$

where Y_{l,m}(\hat{Ω}) are the spherical harmonic functions and φ_{t,m}^{γ}(\vec{r},E′) are the spherical harmonic moments of the photon angular fluence given by

$${φ}_{l , m}^{γ} ( \vec{r} , E ) = {\int }_{4 π} d {Ω}^{′} {Y}_{l , m}^{*} {Ψ}^{γ} ( \vec{r} , {\hat{Ω}}^{′} , E ) . \qquad ( 7 )$$

where * denotes the complex conjugate. Equations (5) through (7) are exact. A limit is generally set on the scattering order, 0≦l≦L, and hence the number of spherical harmonic moments kept in the scattering/production sources. Using the Legendre addition theorem, the scattering and production sources become:

$${q}^{γγ} ( \vec{r} , E , \hat{Ω} ) = {\sum }_{l = 0}^{L} {\sum }_{m = - l}^{l} {\int }_{0}^{∞} d {E}^{′} {σ}_{s , l}^{γγ} ( \vec{r} , {E}^{′} \to E ) {φ}_{l , m}^{γ} ( \vec{r} , {E}^{′} ) {Y}_{l , m} ( \hat{Ω} ) . \qquad ( 8 )$$

The upper limit, L, is chosen to accurately represent the anisotropy of the scattering source.

Discretization in space, angle, and energy is implemented to solve Equation (2), for which any number of deterministic solution methods may be employed.

Once the photon angular fluence is solved, the KERMA approximation to the dose in any region, i, of the problem may be obtained through the following:

$${D}_{i} = {\int }_{0}^{∞} d E {\int }_{4 π} d \hat{Ω} {\int }_{{V}_{vox}} d V \frac{{σ}_{KERMA}^{γ} ( \vec{r} , E )}{ρ} {Ψ}^{γ} ( \vec{r} , E , \hat{Ω} ) . \qquad ( 9 )$$

Here, σ_{KERMA}^{δ}, is the macroscopic KERMA cross section, generally in units of MeV/cm, and ρ is the material density.

The photons exiting each brachytherapy source 101 may be represented as a point source 170 having a full distribution in both energy and angle, which allows for specialized analytic methods to be used to transport the prescribed uncollided (primary) photons through the patient body. Here, patient body refers to anatomical materials in the patient, and where present, mechanical components such as shields, applicators or implants, and may also apply to any medium present in a dose calculation, whether it is performed on a living organism or not.

For a single photon point source, q^{γ}(E,\hat{Ω}), located at position, \vec{r}ₚ Equation (2) becomes:

\hat{Ω}·\vec{∇}Ψ^{γ}+σₜ^{γ}Ψ^{γ}=q^{γγ}+q^{γ}(E,\hat{Ω})δ(\vec{r}−\vec{r}ₚ), (10)

where δ is the Dirac-Delta function.

The principal of linear superposition may be used to define the photon angular fluence as the summation of uncollided and collided fluence components,

Ψ^{γ}≡Ψ_{unc}^{γ}+Ψ_{coll}^{γ}. (11)
where Ψ_{unc}^{γ} is the uncollided, or primary, photon angular fluence and Ψ_{coll}^{γ} is the collided, or secondary, photon angular fluence. In this context, primary refers to photons which have not had an interaction with the patient body, and secondary refers to photons which were produced or scattered by a photon interaction in the patient body. Substituting Equation (11) into Equation (10) and using linear superposition leads to the following system of transport equations:

\hat{Ω}·\vec{∇}Ψ_{unc}^{γ}+σₜ^{γ}Ψ_{unc}^{γ}=q^{γ}(E, \hat{Ω})δ(\vec{r}−\vec{r}ₚ), (12a)

\hat{Ω}·\vec{∇}Ψ_{coll}^{γ}+σₜ^{γ}Ψ_{coll}^{γ}=q_{coll}^{γγ}+q_{unc}^{γγ}, (12b)

The solution to Equation (12) is identical to that of Equation (10). However, Equation (12a) is decoupled from the other two equations and can be solved independently. Once the solution to Equation (12a) is known, q_{unc}^{γγ} is formulated and considered as a fixed source in Equation (12b). This source is referred to as the first scattered photon source.

The desired property of Equation (12a) is that Ψ_{unc}^{γ} can be solved for analytically. Doing so provides the following expression for the uncollided photon angular fluence from a point source:

$$\begin{matrix}{Ψ}_{unc}^{γ} ( \vec{r} , E , \hat{Ω} ) = δ ( \hat{Ω} - {\hat{Ω}}_{\vec{r} , {\vec{r}}_{p}} ) \frac{{q}^{γ} ( E , \hat{Ω} )}{4 π} \frac{{e}^{- τ ( \vec{r} , {\vec{r}}_{p} )}}{{\vert \vec{r} - {\vec{r}}_{p} \vert}^{2}} , \\ where , & ( 13 ) \\ {\hat{Ω}}_{\vec{r} , {\vec{r}}_{p}} = \frac{\vec{r} - {\vec{r}}_{p}}{‖ \vec{r} - {\vec{r}}_{p} ‖} , \\ and & ( 14 )\end{matrix}$$

τ(\vec{r},\vec{r}ₚ) is the optical distance (measured in mean-free-paths) between \vec{r} and \vec{r}ₚ, the source and destination points, respectively, of the ray trace. For multiple point sources, Equation (12a) is repeated for each point source and q_{unc}^{γγ} is formulated as the sum from all point sources. Equation (12b) may be solved once for all point sources combined.

### Ray Tracing

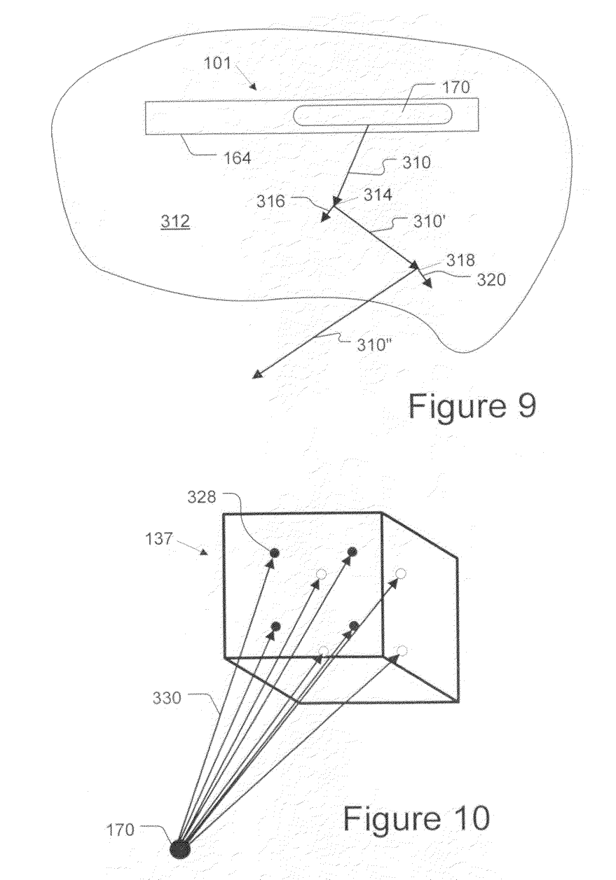

FIG. 9 shows a brachytherapy source 101 formed by a radioactive core 162 contained within a wire 164, such as used for HDR or PDR dosing protocols. For nomenclature, a photon exiting the source surface which has not yet had an interaction with any materials outside the source is referred to as a primary photon. As a primary photon 310 exits the source 101 surface and passes into the patient body 312, a variety of particle interactions may occur, such as scattering, absorption, and secondary particle creation. The primary photon 310 may exit the source 164 surface and travel through the patient body 312 until a collision occurs at a location 314. When the collision occurs, the photon 310 interacts with matter in the patient body, scattering the photon 310′ to travel in a new direction at lower energy. The collision at location 314 also produces a free electron 316 that deposits its energy locally. The photon 310′ then may continue on in the new direction to have another collision at location 318. Another electron 320 then is produced that deposits energy locally. The twice scattered photon 310″ then may exit the patient body at a lower energy. In other examples, even more collisions may occur as the photon continues through the body 312.

According to embodiments of the present invention, energy deposited when the primary photon 310 has it first collision is a primary dose. The energy that is deposited when the reduced energy scattered photon(s) 310′, 310″ move on and have collisions is a secondary dose attributable to scattering. The primary dose and the secondary or scattered dose are calculated and summed to achieve the total dose.

FIG. 10 shows a grid element 137 and a single point source 170 of a brachytherapy radiation source 101. In one embodiment ray tracing is performed, using equation 13, to multiple quadrature points 328, \vec{rₚ}, within a grid element 137. The result is a linear or higher order finite element representation of primary angular photon fluence, Ψ_{unc}^{γ}(\vec{r},E,\hat{Ω}), derived spatially for each grid element 137. Such computation is based on distance and direction of the straight line path 330, along with qualities of the point source 170, and material properties of voxels intersected by the straight line path. The primary angular photon fluence computation for a given grid element 137 is based upon the contributions attributable to each point source. For example, while FIG. 9 shows an element 137 of a first grid 134a being exposed to only one point source 170, in some instances the element 137 may be exposed to multiple point sources originating from one or more brachytherapy sources 101.

The radiation magnitude at a computational grid coordinate will depend upon the magnitude of the point source 170. The point source magnitude will vary according to angle of orientation. For some angles, the point source magnitude will be below a threshold value. Ray tracing and primary photon fluence need not be performed for instances along angles where the magnitude of the point source 170 is less than the threshold value. In addition, ray tracing and primary photon fluence need not be performed for grid elements 137 within voxels 112 having a material density below a user defined threshold.

Accordingly, in one embodiment the dose computation process includes ray tracing from the photon point source(s) to compute Ψ_{unc}^{γ}(\vec{r},E,\hat{Ω}) according to Equation (13). From the results of equation 13, the primary dose is derived using Equation (9) and the first scattered photon source, q_{unc}^{γγ}, is derived using Equation (4). A deterministic photon transport calculation then is performed to compute the scattered photon fluence, Ψ_{coll}^{γ}(\vec{r},E,\hat{Ω}), according to Equation (12b). The results of equation 12b then are used to derive the scattered dose using Equation (9). The total dose is the summation of the primary and scattered doses.

Once Ψ_{unc}^{γ}(\vec{r},E,\hat{Ω}) is calculated in a computational element, q_{unc}^{γγ} may be calculated in that element using Equation (4), where σₛ^{γγ} may be based on the homogenized material properties of that computational element. In one embodiment, σₛ^{γγ}, may be spatially variable within each computational element, based on spatial variations in the material voxel array, or material properties of overlapping surface models.

The first scattered photon source, q_{unc}^{γγ}, calculated through Equation (4) for each element in the computational array, is used as input to a deterministic photon transport calculation to compute the scattered photon fluence, Ψ_{coll}^{γ}(\vec{r},E,\hat{Ω}) according to Equation (12b), and from this calculate the scattered dose through Equation (9). The total dose is the summation of the primary and scattered doses.

Intersected Bodies:

When performing ray traces for a given point source 170, it is noted that in some embodiments the material properties of the brachytherapy source 101 being modeled by the point source may be suppressed (and instead be included in the point source model). In other embodiments, the material properties of the brachytherapy source where a ray trace originates may be considered separately as a surface model distinct from the point source model. In either case, other non-anatomical bodies (e.g., applicators, shields, other brachytherapy sources) also may intersect the ray trace between the given point source and a computational element 328.

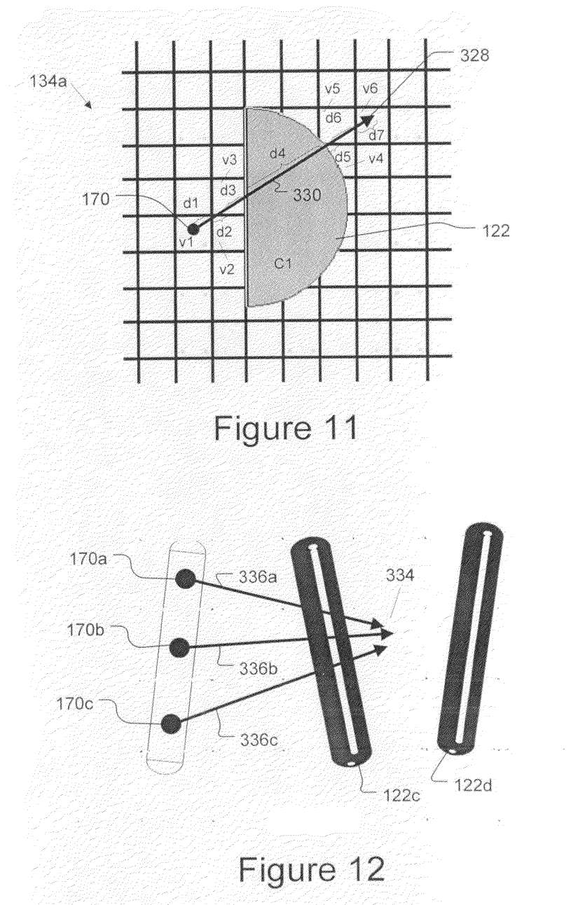

When surface models 122 are present as shown in FIG. 11 τ(\vec{r},\vec{r}ₚ) may be calculated by ray tracing through the surface models 122 of each part which a ray trace 330 intersects. For the distance in which a ray trace passes through the part, τ is calculated using the material properties of that surface body. In such cases, the ray trace continues 330 along its straight line path to the computational element. However, the surface model may be accessed to determine the material properties of the voxels (c1) where such other brachytherapy source, applicator, shield or other non-anatomical body being modeled intersect the ray trace. By using the material properties as defined by a corresponding surface model, the attenuation effects caused by the applicator, shield or other brachytherapy source's casing are considered when deriving the primary photon fluence and scattering photon for such ray trace.

In one embodiment, τ(\vec{r},\vec{r}ₚ) may be calculated by ray tracing on both the surface models and a grid, such as the computational grid or the material voxel grid. For a ray trace performed from a point source, \vec{r}ₚ to \vec{r}, the ray trace 330 proceeds through the first grid 134a, until it intersects the surface body 122. The ray trace 330 continues through the first surface body until it reaches r at location 328. In the example illustrated, τ for equation 13 may be derived as follows:

τ=σᵥₗd1+σᵥ₂d2+σᵥ₃d3+σ_{c1}d4+σᵥ₄d5+σᵥ₅d6+σᵥ₆d7
where d is distance, and vᵢ corresponds to material properties of the voxel corresponding to grid element vᵢ; and c₁ corresponds to material properties of the surface model c₁.

For treatments using brachytherapy source implants, sometime referred to as brachytherapy seeds, surface models 122c,d of brachytherapy seeds may be employed during ray tracing. Referring to FIG. 12, for ray traces performed from the point sources 170a-c, \vec{r}ₚ to location \vec{r} 334, the ray traces 336a-c proceed through the material voxel grid or computational grid, until intersecting a surface body representing a different seed. The ray trace 336 continues through the first surface body 122c until the ray trace 336 exits the body 122c. The ray trace continues through the first grid until the ray trace reaches \vec{r} 334.

For each point \vec{r} to which ray tracing is performed, the primary dose may be calculated using Equation (9), inserting Ψ_{unc}^{γ}(\vec{r},E,\hat{Ω}) for Ψ^{γ}(\vec{r},E,\hat{Ω}). In one embodiment, in computational elements where ray tracing is performed to quadrature integration points, the dose at other points \vec{r}ᵢ inside the computational element may be computed using Equation (9) where Ψ_{unc}^{γ}(\vec{r}ᵢ,E,\hat{Ω}) is calculated from the finite element trial space within that element, or in another embodiment, from another functional representation.

Impact of Brachytherapy Point Source Models:

For brachytherapy sources represented by a plurality of point sources 170, ray traces may be performed from all point sources 170 to points r within a threshold distance to the brachytherapy source. For ray traces to points r exceeding the threshold distance, ray traces may be performed from a single point source 170, representing the cumulative photon fluence exiting the brachytherapy source from the entire radioactive core.

### Pre-Computation Processing

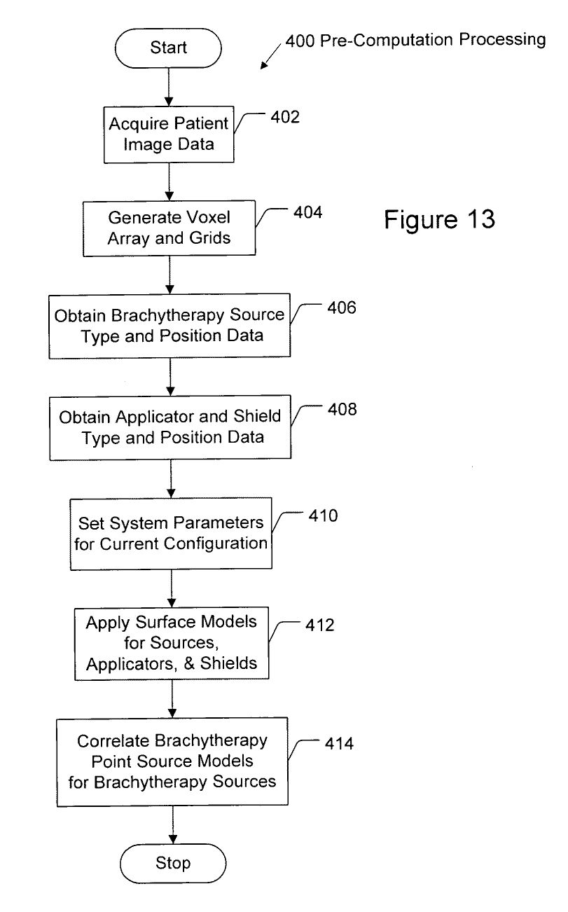

FIG. 13 shows a method of pre-computation processing, according to an embodiment of the present invention. At step 402 patient image data is accessed. Various system parameters also may be accessed for use in converting the image data into material property data. At step 404, the material voxel array 130 is derived from the patient image data and conversion parameters. The voxel array may correspond to an imaged volume of the patient, and may be of varying shape. For example, one portion of the voxel array may be mapped to the pathological target volume 102 (see FIG. 1) or other treatment area. One or more other portions of the voxel array may correspond to nearby critical structures 103, or surrounding tissue. The various portions of the voxel array may, but need not, correspond to a contiguous volume within the patient. Each voxel 112 of the array 130 is of the same dimensions, but may have differing material property values. Further, each voxel may correspond to one or more pixels of the patient image data. The specific granularity of the voxel array relative to the patient image data may be selected by an operator or otherwise set.

At step 404, one or more computation grids 134 also may be generated. Each computation grid, along with the voxel array, corresponds to the same treatment volume 98. In some embodiments a first computation grid is defined for use in computing primary dose, while a second computation grid of coarser granularity is defined for use in computing scattered dose.

At step 406 data pertaining to the brachytherapy sources 101 is obtained, including source type and source position. At step 408 data pertaining to applicators, shields or other non-anatomical bodies is obtained, including body type and position. At step 410, various system parameters may be set. For example, the threshold distance used for determining whether to treat a brachytherapy source as a single point source or multiple point sources may be set.

At step 412 the surface models are accessed for each of the non-anatomical bodies applicable to a given treatment. For example, for each of the non-anatomical bodies identified at steps 406 and 408, surface models are accessed and in effect mapped to the voxel array (and thus to the computational grid(s)). Specifically, for each voxel or computational array element corresponding to a portion of a non-anatomical body, the material property of the voxel and elements are updated to account for radiation attenuation effects of the non-anatomical body.

At step 414, the brachytherapy point source models are accessed and positioned within the voxel array and computation grids for each brachytherapy source. Note that although a brachytherapy source may include a single point source model and a multiple point source model, the specific model to be used during dose computations may be decided at the time of such computation. The other model, if any, is ignored for such computation.

Although a specific order of pre-computation steps is recited, one of skill in the art of brachytherapy simulation and treatment planning software design will appreciate that the specific order of steps may vary. For example, the data acquisition steps may all be performed prior to generating the voxel array and computation grids, and applying the surface models and point source models. Other step order permutations also may be implemented.

### Dose Computation Processing

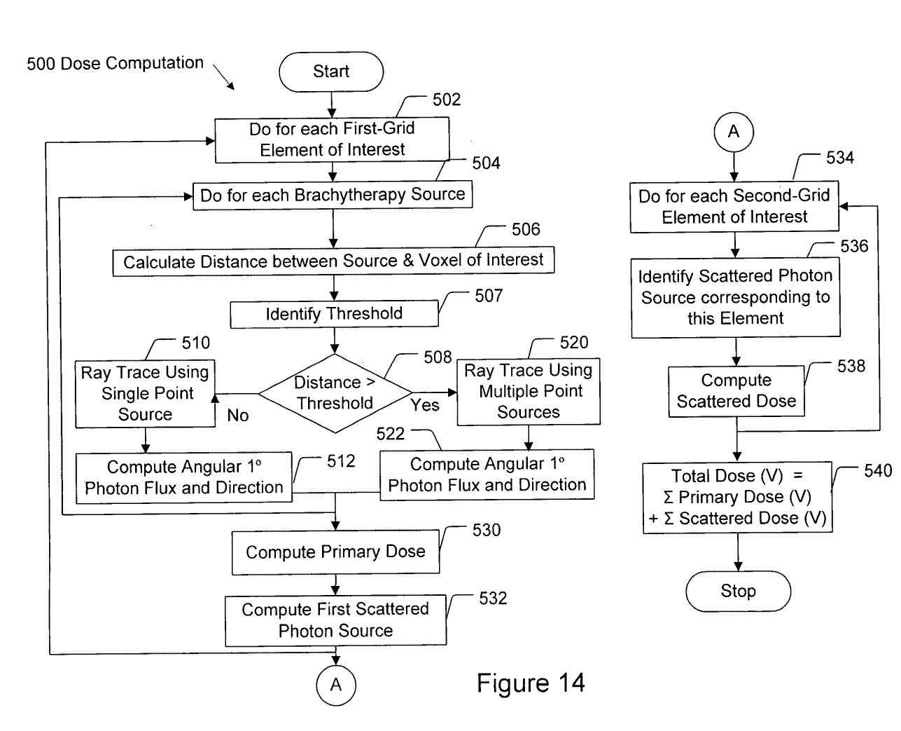

FIG. 14 shows a flow chart of a dose computation method 500, according to an embodiment of the present invention. Dose computation may be performed for each first grid element and each second grid element, as indicated by the “do loop” structures. Note that the program structure may vary, such as where only one grid is derived for computing both primary dose and scattered dose. At step 502 the process is set up to be performed for each one of multiple first-grid elements. At step 504, dose computation processing is set up to be performed for each brachytherapy source. Accordingly, for each first grid element dose computations are performed for each brachytherapy source.

In some embodiments, a threshold distance may be used for determining how to apply a point source model for a brachytherapy source. At step 506, the distance between a centroid of the current brachytherapy source and first-grid element being processed is calculated. At step 507, the threshold distance is obtained. When the path from the brachytherapy source to the first-grid element intersects a surface model, a threshold distance based upon the attenuating effects of the body being modeled is identified. Such threshold distance may differ for different surface models. When the path does not intersect a surface model, then a standard threshold distance that may be prescribed or selected is identified. At step 508, the distance is tested to determine whether the distance exceeds the identified threshold distance. When the calculated distance is not greater than the threshold distance, steps 510-512 are performed, for which a single point source model of the brachytherapy source is used. When the calculated distance is greater than the threshold distance, steps 520-522 are performed, for which a multiple point source model of the brachytherapy source is used. The specific number of multiple point sources may vary according to the model implemented. Further, in some embodiments multiple threshold distances may be defined for selecting among multiple alternative models having a varying number of point sources. It is noted that in alternative embodiments, a single point source is used for each brachytherapy source. In still other embodiments multiple point sources are used for each brachytherapy source. Further in some embodiments, a single grid is used for computing primary and scattered dose. In other embodiments, one grid is used for computing primary dose and a second grid is used for computing secondary dose.

At step 510, ray tracing is performed using a single point source model for the brachytherapy source. Ray tracing as previously described includes identifying the path from the point source to the first-grid element, and solving equation 13. In applying equation 13, the material properties as defined by a surface model may be used for distance portions (as described, for example with regard to FIG. 11 above), rather than those derived from the acquired patient image data. Such substitution is performed for voxels to which a surface model is mapped. Note however, that the surface model for the brachytherapy source containing the point source originating the ray trace is suppressed. Surface models or other brachytherapy sources, applicators, shields and any other non-anatomical bodies may be considered.

At step 512 angular primary photon flux and direction, Ψ_{unc}^{γ}(\vec{r},E,\hat{Ω}) according to Equation (13), attributable to a given point source at a given first-grid element are computed. In particular at step 512 an angular primary photon flux and direction attributable to a given point source at a given first-grid element are computed.

For the case where the calculated distance at step 506 exceeds the threshold distance, ray tracing is performed at step 520 using multiple point sources. At step 522 angular primary photon flux and direction, Ψ_{unc}^{γ}(\vec{r},E,\hat{Ω}) according to Equation (13), attributable to the combined effect of each one of the multiple sources at a given first-grid element are computed.

Steps 506-522 then are repeated for each brachytherapy source 101. Once complete there is an angular primary photon flux and direction stored for a given first-grid element for each brachytherapy source.

At step 530, primary dose is derived using Equation (9) for the given first-grid element. At step 532, the first scattered photon source, q_{unc}^{γγ}, is derived at step 514 using Equation (4) for the given first-grid element.

Subsequent steps then are performed for each second-grid element corresponding to the same treatment volume as encompassed by the processing for first-grid elements at steps 502-532. At step 534 a do loop structure may be set up. At step 536, a scattered photon source to be used for deriving scattered dose for a given second-grid element is identified. The scattered photon source to be used is the source derived at step 532 for a first-grid element corresponding to the same volume portion of the treatment volume as the current given second-grid element. A deterministic photon transport calculation then is performed to compute the scattered photon fluence, Ψ_{coll}^{γ}(\vec{r},E,\hat{Ω}), according to Equation (12b). The results of equation 12b then are used to derive the scattered dose at step 538 using Equation (9) for the given second-grid element. The computations are repeated to derive a scattered dose for each second-grid element in the treatment volume of interest.

Accordingly, a primary dose is computed and stored for each first-grid element within a treatment volume of interest, and a scattered, or secondary, dose is computed and stored for each second-grid element within the treatment volume of interest. The treatment volume of interest may be all or any portion of the treatment volume 98. For example, computations may be performed for a portion of the treatment volume 98 corresponding to any or all of a target volume 102 and critical structures 103. As another example, computations may be performed for a portion of the treatment volume 98 corresponding to a portion of the target volume 102, a portion of a critical structure 103, or any other portion of the treatment volume 98.

At step 540 the total dose may be computed for the treatment volume of interest. Total dose for a given treatment volume of interest is the sum of the primary doses computed for each first-grid element in such treatment volume of interest, plus the sum of the scattered doses computed for each second-grid element in the same treatment volume of interest. As a result, total dose for a target volume 102, or some portion thereof may be derived. Similarly, total dose for a critical structure 103, or some portion thereof may be derived. Further, in some embodiments, total dose for each of several non-overlapping portions of the target volume 102 (or critical structure 103) may be computed to indicate how dose is distributed throughout the target volume (or critical structure 103).

The dose computation method 500 may be implemented for varying purposes. For example, the method 500 may be performed for a given configuration (e.g., types, number, and positions) of brachytherapy sources. Total dose may be computed at the target volume 102 for such configuration. Respective other total doses also may be computed for one or more critical structures 103 for such configuration. The results then may be analyzed to determine whether critical structures 103 are being exposed to only safe amounts of radiation, and target volumes (e.g., pathological structures such as tumors) are being exposed to sufficient treatment doses of radiation.

### Brachytherapy Treatment Planning

In afterloader brachytherapy using HDR, PDR, or low dose rate (LDR) sources, catheters or applicators are positioned inside the patient prior to treatment. Each catheter or applicator has one or more channels, along which a source can travel. A treatment plan is developed in which the source positions along each channel are selected, along with corresponding dwell times for each position. During the development and optimization of a single treatment plan, numerous dose calculations may be performed. During HDR and PDR treatments, an afterloader may incrementally move a single source, attached to a wire, to each specified position for the corresponding dwell time.

In implant brachytherapy, seeds are placed inside the treatment volume with a distribution that will both provide a high degree of dose conformity throughout the treatment volume, and a minimal dose to neighboring tissue and critical structures.

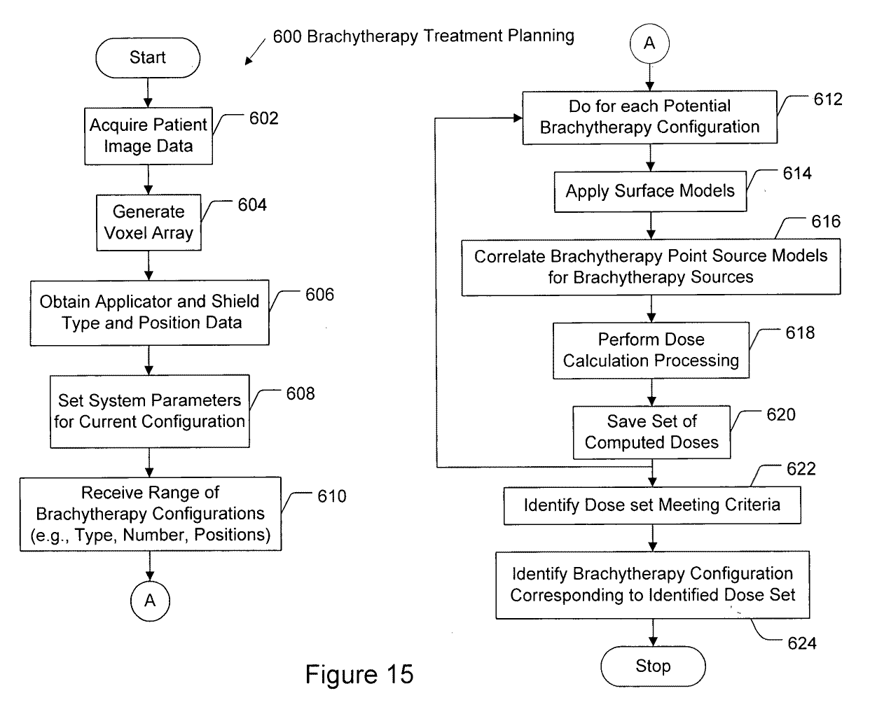

FIG. 15 shows a flow chart of a brachytherapy treatment planning method 600, according to an embodiment of the present invention. The brachytherapy treatment planning may be implemented to evaluate alternative configurations of brachytherapy sources and identify one or more configurations as optimal, or as meeting desired criteria.

At step 602 patient image data is accessed. Various system parameters also may be accessed for use in converting the image data into material property data. At step 604, the material voxel array 130 and computation grids 134 are derived. The voxel array is derived from the patient image data and conversion parameters for a given treatment volume. The computation grids correspond to the same treatment volume, and may have the same or different grid element volumes.

As previously described with regard to the pre-computation process 400, each voxel 112 of the array 130 is of the same dimensions, but may have differing material property values, and may correspond to one or more pixels of the patient image data. The specific granularity of the voxel array relative to the patient image data may be selected by an operator or otherwise set. The computation grids in effect overlay the voxel array, and may have the same or a different granularity than the voxel array. In some embodiments a first computation grid is defined for use in computing primary dose, while a second computation grid of coarser granularity is defined for use in computing scattered dose.

At step 606 data pertaining to applicators, shields or other non-anatomical bodies is obtained, including body type and position. At step 608, various system parameters may be set. For example, the threshold distance(s) to be used for determining whether to treat a brachytherapy source as a single point source or multiple point sources may be set.

At step 610 data corresponding to the various brachytherapy configuration permutations are received. A given configuration includes a given number of brachytherapy sources and respective locations for each source. In differing configurations, the number of brachytherapy sources, the types of brachytherapy sources and/or the relative positions of the brachytherapy sources may vary.

Each permutation is to be evaluated to plan the brachytherapy treatment. At step 612, a “do loop” may be implemented to perform the dose computation process 500 for each configuration. At step 614 the surface models are accessed and applied for each of the non-anatomical bodies applicable to a given treatment. For example, for each of the non-anatomical bodies identified at steps 606 and 610, surface models are accessed and in effect mapped to the voxel array (and thus to the computational grid(s)). Specifically, for each voxel corresponding to a portion of a non-anatomical body, the material property of the voxel is updated to account for radiation attenuation effects of the non-anatomical body.

At step 614, the brachytherapy point source models are accessed and positioned within the voxel array and computation grids for each brachytherapy source. Note that although a brachytherapy source may include a single point source model and a multiple point source model, the specific model to be used during dose computations may be decided at the time of such computation. The other model, if any, is ignored for such computation.

At step 618, the dose computation process 500 is performed for the current configuration being evaluated. The dose results for each grid element computed for such configuration are saved in memory at step 620. The steps 614 to 620 then are repeated for the next configuration. Note that in some embodiments, surface models for bodies that have positions unchanged for all configurations may be applied before the iterative processing of steps 612-620, and thus need not be iteratively re-applied.

Once each of the potential configurations have been evaluated, the results for each configuration may be compared at step 622. In particular, the dose results stored for each configuration may be analyzed to determine which set(s) of results meets specific criteria. For example, criteria may be defined where a select group of grid elements is to receive a total dose of at least some first radiation level. This radiation level may be a desired treatment dose, and these grid elements may correspond to the pathological tissue (e.g., tumor) to be treated. Such criteria may be further defined where a second select group of grid elements is to receive a total dose of less than some prescribed safe level. These grid elements may correspond to a critical structure which is not to be exposed to unsafe levels of radiation. Further criteria may be defined for other grid elements corresponding to other structures or tissue. When multiple dose sets comply with all the criteria, then an optimal dose set may be selected which minimizes radiation exposure to critical structures and surrounding tissue, while meeting desired treatment dose levels at the pathological structures to be treated.

At step 624, the configuration corresponding to the identified dose set or optimal dose set may be identified. The identified configuration then may be output, configured, or otherwise identified to operators for setting up and performing brachytherapy treatment. Further, in some embodiments several brachytherapy configurations may be identified which meet the criteria or which best meet the criteria, allowing the operators to pick the one configuration to be used in treatment.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method for computing dose at a given volume attributable to a brachytherapy source, comprising:
modeling each one brachytherapy source as plurality of radiation point sources, wherein each one of the plurality of point sources has a distinct location and models a source of photons exiting the brachtherapy source from a distinct segment of a radioactive core of the brachytherapy source being modeled;
for each one of multiple first locations within said given volume, computing respective primary particle fluence attributable to each one of said plurality of point sources, and computing a primary dose from the respective primary particle fluence; and
computing a total dose for the given volume, wherein the total dose is a sum of primary doses derived for said first locations, respectively, within said given volume.

2. The method of claim 1, further comprising the steps of:
computing a scattered particle fluence for each one of multiple second locations within said given volume based upon one or more corresponding first scattered particle sources, and computing a secondary dose from said computed scattered particle fluence; and
wherein for each one of multiple first locations within said given volume, computing the primary dose and a first scattered particle source from the respective primary particle fluence; and
wherein the step of computing total dose comprises computing total dose for the given volume, wherein the total dose is a sum of primary doses and secondary doses derived for said first and second locations, respectively, within said given volume.

3. The method of claim 1, wherein the step of modeling comprises, representing the brachytherapy source as a single point source for computations pertaining to locations beyond a first distance from the brachytherapy source, and representing the brachytherapy source as a plurality of point sources for computations pertaining to locations within said first distance.

4. The method of claim 1, further comprising the step of:
deriving a grid comprising an array of voxels, each voxel having associated material property data; and
wherein the step of computing respective primary particle fluence comprises computing respective primary particle fluence attributable to said set of point sources using a ray tracing process that accesses the material property data of intersected voxels, and computing the primary dose from the respective primary particle fluence.

5. The method of claim 2, wherein the step of deriving a grid comprises:
deriving a plurality of grids, each grid corresponding to a common patient treatment volume, wherein a first grid and a second grid of said plurality of grids have differing scales for relating grid elements to the patient treatment volume, and wherein a material voxel grid comprises an array of voxels, each voxel having associated material property data; and
wherein the step of computing respective primary particle fluence comprises computing respective primary particle fluence attributable to said set of point sources using a ray tracing process that accesses the material property data of intersected voxels, and computing the primary dose and the first scattered particle source from the respective primary particle fluence;
wherein the step of computing a scattered particle fluence comprises for each one element of a plurality of elements on the second grid, computing the scattered particle fluence based upon one or more corresponding first scattered particle sources, and computing the secondary dose from said computed scattered particle fluence; and
wherein the step of computing total dose comprises computing total dose for the given volume commonly corresponding to a set of elements of the first grid and a set of elements of the second grid, wherein the total dose is a sum of primary doses derived for said set of elements of the first grid and secondary doses derived for said set of elements of the second grid.

6. The method of claim 1, wherein the step of modeling comprises, representing the brachytherapy source as a single point source for computations pertaining to grid elements beyond a first distance from the brachytherapy source, and representing the brachytherapy source as a plurality of point sources for computations pertaining to grid elements located within said first distance.

7. The method of claim 1, wherein the step of modeling comprises, representing a brachytherapy source as a plurality of point sources, wherein each one of the plurality of point sources has a distinct location and corresponds to a distinct segment of a radioactive core of the brachytherapy source being modeled.

8. The method of claim 1, for computing dose attributable to a plurality of brachytherapy sources for a volume of interest within the patient treatment volume, wherein said step of computing primary particle fluence is repeated for each one source of the plurality of brachytherapy sources.

9. The method of claim 2, for computing dose attributable to a plurality of brachytherapy sources for a volume of interest within the patient treatment volume, as part of a method for developing a treatment plan, and further comprising the steps of:
repeating the steps of computing primary particle fluence, computing scattered particle fluence, and computing total dose for various brachytherapy source configurations.

10. The method of claim 9, further comprising the step of selecting a brachytherapy source configuration to be used in treatment based upon criteria for providing a desired dose to a target volume within the patient treatment volume, and for limiting dose at patient structures prescribed to be critical structures.

11. The method of claim 4, further comprising:
accessing the acquired patient image data, which comprises a plurality of pixels;
for each voxel of the voxel array, defining each one voxel as comprising a contiguous volume of one or more pixels, wherein each one voxel has the same dimensions; and
for said each one voxel, analyzing the corresponding one or more pixels of the acquired image data to assign material properties to said each one voxel.

12. The method of claim 4, further comprising:
identifying presence of a non-anatomical structure; and
for any voxel of the voxel array corresponding to location of the non-anatomical structure, assigning material properties based upon a model of the non-anatomical structure.

13. The method of claim 12, wherein for computing dose for a given one of said multiple first locations from a given brachytherapy source, the non-anatomical structure properties of the brachytherapy source are considered in the point source model and the non-anatomical structure model of said brachytherapy source is otherwise ignored.

14. The method of claim 12, wherein the step of brachytherapy source modeling comprises, representing the brachytherapy source as a single point source for computations pertaining to grid elements beyond a threshold distance from the brachytherapy source, and representing the brachytherapy source as a plurality of point sources for computations pertaining to grid elements located within said threshold distance; and further comprising:
defining the threshold distance to be a first distance for ray tracing processes which intersect a location corresponding to a portion of the model of the non-anatomical structure; and
defining the threshold distance to be a second distance for ray tracing processes which do not intersect locations corresponding to non-anatomical structure.

15. A system for computing dose at a given volume attributable to a brachytherapy source, comprising:
means for modeling each one brachytherapy source as plurality of radiation point sources, wherein each one of the plurality of point sources has a distinct location and models a source of photons exiting the brachtherapy source from a distinct segment of a radioactive core of the brachytherapy source being modeled;
means for computing, for each one of multiple first locations within said given volume, respective primary particle fluence attributable to each one of said plurality of point sources, and for computing a primary dose from the respective primary particle fluence; and
means for computing a total dose for the given volume, wherein the total dose is a sum of primary doses derived for said first locations, respectively, within said given volume.

16. The system of claim 15, further comprising:
means for computing a scattered particle fluence for each one of multiple second locations within said given volume based upon one or more corresponding first scattered particle sources, and for computing a secondary dose from said computed scattered particle fluence; and
means for computing, wherein for each one of multiple first locations within said given volume, the primary dose and a first scattered particle source from the respective primary particle fluence; and
wherein the means for computing total dose comprises computing total dose for the given volume, wherein the total dose is a sum of primary doses and secondary doses derived for said first and second locations, respectively, within said given volume.

17. The system of claim 15, wherein the means for modeling comprises, means for representing the brachytherapy source as a single point source for computations pertaining to locations beyond a first distance from the brachytherapy source, and means for representing the brachytherapy source as a plurality of point sources for computations pertaining to locations within said first distance.

18. The system of claim 15, further comprising:
means for deriving a grid comprising an array of voxels, each voxel having associated material property data; and
wherein the means computing respective primary particle fluence comprises means for computing respective primary particle fluence attributable to said set of point sources using a ray tracing process that accesses the material property data of intersected voxels, and for computing the primary dose from the respective primary particle fluence.

19. The system of claim 16, wherein the means for deriving a grid comprises:
means for deriving a plurality of grids, each grid corresponding to a common patient treatment volume, wherein a first grid and a second grid of said plurality of grids have differing scales for relating grid elements to the patient treatment volume, and wherein a material voxel grid comprises an array of voxels, each voxel having associated material property data; and
wherein the means for computing respective primary particle fluence comprises means for computing respective primary particle fluence attributable to said set of point sources using a ray tracing process that accesses the material property data of intersected voxels, and means for computing the primary dose and the first scattered particle source from the respective primary particle fluence;
wherein the means for computing a scattered particle fluence comprises for each one element of a plurality of elements on the second grid, means for computing the scattered particle fluence based upon one or more corresponding first scattered particle sources, and means for computing the secondary dose from said computed scattered particle fluence; and
wherein the means for computing total dose comprises means for computing total dose for the given volume commonly corresponding to a set of elements of the first grid and a set of elements of the second grid, wherein the total dose is a sum of primary doses derived for said set of elements of the first grid and secondary doses derived for said set of elements of the second grid.

20. The system of claim 15, wherein the means for modeling comprises, means for representing the brachytherapy source as a single point source for computations pertaining to grid elements beyond a first distance from the brachytherapy source, and means for representing the brachytherapy source as a plurality of point sources for computations pertaining to grid elements located within said first distance.

21. The system of claim 15, wherein the means for modeling comprises, means for representing a brachytherapy source as a plurality of point sources, wherein each one of the plurality of point sources has a distinct location and corresponds to a distinct segment of a radioactive core of the brachytherapy source being modeled.

22. The system of claim 15, for computing dose attributable to a plurality of brachytherapy sources for a volume of interest within the patient treatment volume, wherein said means for computing primary particle fluence computes primary particle fluence for each one source of the plurality of brachytherapy sources.

23. The system of claim 22, further comprising means for selecting a brachytherapy source configuration to be used in treatment based upon criteria for providing a desired dose to a target volume within the patient treatment volume, and further criteria for limiting dose at patient structures prescribed to be critical structures.

24. The system of claim 18, further comprising:
means for accessing the acquired patient image data, which comprises a plurality of pixels;
means for defining, for each voxel of the voxel array, each one voxel as comprising a contiguous volume of one or more pixels, wherein each one voxel has the same dimensions; and
means for analyzing, for said each one voxel, the corresponding one or more pixels of the acquired image data to assign material properties to said each one voxel.

25. The system of claim 18, further comprising:
means for identifying presence of a non-anatomical structure; and
means for assigning, for any voxel of the voxel array corresponding to location of the non-anatomical structure, material properties based upon a model of the non-anatomical structure.

26. The system of claim 24, wherein the means for modeling the brachytherapy source comprises, means for representing the brachytherapy source as a single point source for computations pertaining to grid elements beyond a threshold distance from the brachytherapy source, and means for representing the brachytherapy source as a plurality of point sources for computations pertaining to grid elements located within said threshold distance; and further comprising:
means for defining the threshold distance to be a first distance for ray tracing processes which intersect a location corresponding to a portion of the model of the non-anatomical structure; and
means for defining the threshold distance to be a second distance for ray tracing processes which do not intersect locations corresponding to non-anatomical structure.

27. A brachytherapy dose computation software program which may be stored in memory, accepts image data as an input, and computes dose attributable to a brachytherapy source for a first volume corresponding to a portion of the image data, the software program comprising:
data code means for converting image pixel data of the accepted image data to material property data;
instruction code means for deriving a grid corresponding to a common patient treatment volume and comprising an array of voxels, each voxel having associated material property data;
data code means for modelling a brachytherapy source as plurality of point sources, wherein each one of the plurality of point sources has a distinct location and models a source of photons exiting the brachtherapy source from a distinct segment of a radioactive core of the brachytherapy source being modeled;
instruction code means for computing, for each one element of a plurality of elements on the grid, respective primary particle fluence attributable to said set of point sources using a ray tracing process that accesses the material property data of intersected voxels, and computing a primary dose from the respective primary particle fluence; and
instruction code means for computing a total dose for the first volume, the first volume commonly corresponding to a set of elements of the grid and wherein the total dose is a sum of primary doses derived for said set of elements of the grid.

28. The software program of claim 27,
wherein the instruction code means for deriving a grid comprises instruction code means for deriving a plurality of grids, each grid corresponding to a common patient treatment volume, wherein a first grid and a second grid of said plurality of grids have differing scales for relating grid elements to the patient treatment volume, and wherein the material voxel array corresponds to either one or both of the first grid and the second grid;
wherein the instruction code means for computing, for each one element of a plurality of elements on the first grid, respective primary particle fluence further comprises instruction code means for computing a first scattered particle source from the respective primary particle fluence;
further comprising instruction code means for computing, for each one element of a plurality of elements on the second grid, a scattered particle fluence based upon one or more corresponding first scattered particle sources, and computing a secondary dose from said scattered particle fluence; and
wherein for the instruction code means for computing the total dose for the first volume, the first volume commonly corresponding to a set of elements of the first grid and a set of elements of the second grid, and wherein the total dose is a sum of primary doses derived for said set of elements of the first grid and secondary doses derived for said set of elements of the second grid.

29. The software program of claim 27, further comprising instruction code means for representing the brachytherapy source as a single point source for grid elements located beyond a first distance from the brachytherapy source, and representing the brachytherapy source as a plurality of point sources for grid elements located within said first distance.

30. The software program of claim 27, further comprising:
data code means representing respective configurations of a plurality of brachytherapy sources; and
instruction code means for selecting a configuration of the plurality of brachytherapy sources to be used in treatment based upon criteria for providing a desired dose to a patient target volume within the patient treatment volume, and for limiting dose at patient structures prescribed to be critical structures.

31. The software program of claim 27, further comprising:
data code means embodying a model of a non-anatomical body; and
instruction code means for applying said non-anatomical body model to a first plurality of voxels to provide material properties for said first plurality of voxels which model attenuation effects of the non-anatomical body.

32. A method for computing a brachytherapy dose attributable to a brachytherapy source, comprising:
deriving a plurality of grids, each grid corresponding to a common patient treatment volume, wherein a first grid and a second grid of said plurality of grids have differing scales for relating grid elements to the patient treatment volume, and wherein a material voxel grid comprises an array of voxels, each voxel having associated material property data;
modeling each one brachytherapy source as set of one or more radiation point sources;
for each one element of a plurality of elements of the first grid, computing respective primary particle fluence attributable to said set of point sources using a ray tracing process that accesses the material property data of intersected voxels, and computing a primary dose and a first scattered particle source from the respective primary particle fluence;
for each one element of a plurality of elements on the second grid, computing a scattered particle fluence based upon one or more corresponding first scattered particle sources, and computing a secondary dose from said computed scattered particle fluence; and
computing a total dose for a given volume commonly corresponding to a set of elements of the first grid and a set of elements of the second grid, wherein the total dose is a sum of primary doses derived for said set of elements of the first grid and secondary doses derived for said set of elements of the second grid.

33. The method of claim 32, wherein the first grid and the material voxel grid are the same.

34. The method of claim 32, wherein each one element of the second grid corresponds to a contiguous plurality of elements of the first grid.

35. The method of claim 32, for computing a brachytherapy dose attributable to a plurality of brachytherapy sources for a volume of interest within the patient treatment volume, wherein said step of computing primary particle fluence is repeated for each one source of the plurality of brachytherapy sources.

36. The method of claim 35, as part of a method for developing a treatment plan, and further comprising the steps of:
repeating the steps of computing primary particle fluence, computing scattered particle fluence, and computing total dose for various brachytherapy source configurations.

37. The method of claim 36, further comprising the step of selecting a brachytherapy source configuration to be used in treatment based upon criteria for providing a desired dose to a target volume within the patient treatment volume, and for limiting dose at patient structures prescribed to be critical structures.

38. The method of claim 35, further comprising:
accessing the acquired patient image data, which comprises a plurality of pixels;
for each voxel of the voxel array, defining each one voxel as comprising a contiguous volume of one or more pixels, wherein each one voxel has the same dimensions; and
for said each one voxel, analyzing the corresponding one or more pixels of the acquired image data to assign material properties to said each one voxel.

39. The method of claim 35, further comprising:
identifying presence of a non-anatomical structure; and
for any voxel of the voxel array corresponding to location of the non-anatomical structure, assigning material properties based upon a model of the non-anatomical structure.

40. A system for computing a brachytherapy dose attributable to a brachytherapy source for a patient target volume, comprising:
means for deriving a plurality of grids, each grid corresponding to a common patient treatment volume, wherein a first grid and a second grid of said plurality of grids have differing scales for relating grid elements to the patient treatment volume, and wherein a material voxel grid comprises an array of voxels, each voxel having associated material property data;
means for modeling each one brachytherapy source as set of one or more radiation point sources;
means for computing, for each one element of a plurality of elements of the first grid, respective primary particle fluence attributable to said set of point sources using a ray tracing process that accesses the material property data of intersected voxels, and computing a primary dose and a first scattered particle source from the respective primary particle fluence;
means for computing, for each one element of a plurality of elements on the second grid, a scattered particle fluence based upon one or more corresponding first scattered particle sources, and computing a secondary dose from said computed scattered particle fluence; and
means for computing a total dose for a given volume commonly corresponding to a set of elements of the first grid and a set of elements of the second grid, wherein the total dose is a sum of primary doses derived for said set of elements of the first grid and secondary doses derived for said set of elements of the second grid.

41. The system of claim 40, further comprising:
means for selecting locations of the plurality of brachytherapy sources to be used in treatment based upon criteria for providing a desired dose to a patient target volume within the patient treatment volume, and for limiting dose at patient structures prescribed to be critical structures.

42. The system of claim 40, further comprising:
means for accessing the acquired patient image data, which comprises a plurality of pixels;
means for defining, for each voxel of the voxel array, each one voxel as comprising a contiguous volume of one or more pixels, wherein each one voxel has the same dimensions; and
means for analyzing, for said each one voxel, the corresponding one or more pixels of the acquired image data to assign material properties to said each one voxel.

43. The system of claim 40, further comprising:
means for identifying presence of a non-anatomical structure; and
means for assigning, for any voxel of the voxel array corresponding to location of the non-anatomical structure, material properties based upon a model of the non-anatomical structure.

44. A brachytherapy dose computation software program which may be stored in memory, accepts image data as an input, and computes brachytherapy dose attributable to a brachytherapy source for a first volume corresponding to a portion of the image data, the software program comprising:
data code means for converting image pixel data of the accepted image data to material property data;
instruction code means for deriving a plurality of grids, each grid corresponding to a common patient treatment volume, wherein a first grid and a second grid of said plurality of grids have differing scales for relating grid elements to the patient treatment volume, and wherein a material voxel grid comprises an array of voxels, each voxel having associated material property data;
data code means for modelling a brachytherapy source as one or more point sources;
instruction code means for computing, for each one element of a plurality of elements on the first grid, respective primary particle fluence attributable to said set of point sources using a ray tracing process that accesses the material property data of intersected voxels, and computing a primary dose and a first scattered particle source from the respective primary particle fluence;
instruction means for computing, for each one element of a plurality of elements on the second grid, a scattered particle fluence based upon one or more corresponding first scattered particle sources, and computing a secondary dose from said scattered particle fluence; and
instruction code means for computing a total dose for the first volume, the first volume commonly corresponding to a set of elements of the first grid and a set of elements of the second grid, wherein the total dose is a sum of primary doses derived for said set of elements of the first grid and secondary doses derived for said set of elements of the second grid.

45. The software program of claim 44, further comprising:
data code means representing respective configurations of a plurality of brachytherapy sources; and
instruction code means for selecting a configuration of the plurality of brachytherapy sources to be used in treatment based upon criteria for providing a desired dose to a patient target volume within the patient treatment volume, and for limiting dose at patient structures prescribed to be critical structures.

46. The software program of claim 44, further comprising:
data code means embodying a model of a non-anatomical body; and
instruction code means for applying said non-anatomical body model to a first plurality of voxels to provide material properties for said first plurality of voxels which model attenuation effects of the non-anatomical body.

47. A method for computing a brachytherapy dose attributable to a brachytherapy source, comprising:
deriving a plurality of grids, each grid corresponding to a common patient treatment volume, wherein a first grid and a second grid of said plurality of grids have differing scales for relating grid elements to the patient treatment volume, and wherein a material voxel grid comprises an array of voxels, each voxel having associated material property data;
modeling each one brachytherapy source as a plurality of radiation point sources;
for each one element of a plurality of elements of the first grid, computing respective primary particle fluence attributable to said set of point sources using a ray tracing process that accesses the material property data of intersected voxels, and computing a primary dose and a first scattered particle source from the respective primary particle fluence;
for each one element of a plurality of elements on the second grid, computing a scattered particle fluence based upon one or more corresponding first scattered particle sources, and computing a secondary dose from said computed scattered particle fluence; and
computing a total dose for a given volume commonly corresponding to a set of elements of the first grid and a set of elements of the second grid, wherein the total dose is a sum of primary doses derived for said set of elements of the first grid and secondary doses derived for said set of elements of the second grid.

48. The method of claim 47, wherein the first grid and the material voxel grid are the same.

49. The method of claim 47, wherein each one element of the second grid corresponds to a contiguous plurality of elements of the first grid.

50. The method of claim 47, for computing a brachytherapy dose attributable to a plurality of brachytherapy sources for a volume of interest within the patient treatment volume, wherein said step of computing primary particle fluence is repeated for each one source of the plurality of brachytherapy sources.

51. The method of claim 47, wherein the step of modeling comprises, representing the brachytherapy source as a first number of point sources for computations pertaining to grid elements beyond a first distance from the brachytherapy source, and representing the brachytherapy source as a second number of point sources for computations pertaining to grid elements located within said first distance, wherein said first number is greater than said second number.

52. The method of claim 48, as part of a method for developing a treatment plan, and further comprising the steps of:
repeating the steps of computing primary particle fluence, computing scattered particle fluence, and computing total dose for various brachytherapy source configurations.

53. The method of claim 52, further comprising the step of selecting a brachytherapy source configuration to be used in treatment based upon criteria for providing a desired dose to a target volume within the patient treatment volume, and for limiting dose at patient structures prescribed to be critical structures.

54. A system for computing a brachytherapy dose attributable to a brachytherapy source for a patient target volume, comprising:
means for deriving a plurality of grids, each grid corresponding to a common patient treatment volume, wherein a first grid and a second grid of said plurality of grids have differing scales for relating grid elements to the patient treatment volume, and wherein a material voxel grid comprises an array of voxels, each voxel having associated material property data;
means for modeling each one brachytherapy source as a plurality of radiation point sources;
means for computing, for each one element of a plurality of elements of the first grid, respective primary particle fluence attributable to said set of point sources using a ray tracing process that accesses the material property data of intersected voxels, and computing a primary dose and a first scattered particle source from the respective primary particle fluence;
means for computing, for each one element of a plurality of elements on the second grid, a scattered particle fluence based upon one or more corresponding first scattered particle sources, and computing a secondary dose from said computed scattered particle fluence; and
means for computing a total dose for a given volume commonly corresponding to a set of elements of the first grid and a set of elements of the second grid, wherein the total dose is a sum of primary doses derived for said set of elements of the first grid and secondary doses derived for said set of elements of the second grid.

55. The system of claim 54, wherein the means for modeling comprises, means for representing the brachytherapy source as a first number of point sources for grid elements located beyond a first distance from the brachytherapy source, and means for representing the brachytherapy source as a second number of point sources for grid elements located within said first distance.

56. The system of claim 54, further comprising:
means for selecting locations of the plurality of brachytherapy sources to be used in treatment based upon criteria for providing a desired dose to a patient target volume within the patient treatment volume, and for limiting dose at patient structures prescribed to be critical structures.

57. A brachytherapy dose computation software program which may be stored in memory, accepts image data as an input, and computes brachytherapy dose attributable to a brachytherapy source for a first volume corresponding to a portion of the image data, the software program comprising:
data code means for converting image pixel data of the accepted image data to material property data;
instruction code means for deriving a plurality of grids, each grid corresponding to a common patient treatment volume, wherein a first grid and a second grid of said plurality of grids have differing scales for relating grid elements to the patient treatment volume, and wherein a material voxel grid comprises an array of voxels, each voxel having associated material property data;
data code means for modelling a brachytherapy source as a plurality of point sources;
instruction code means for computing, for each one element of a plurality of elements on the first grid, respective primary particle fluence attributable to said set of point sources using a ray tracing process that accesses the material property data of intersected voxels, and computing a primary dose and a first scattered particle source from the respective primary particle fluence;
instruction means for computing, for each one element of a plurality of elements on the second grid, a scattered particle fluence based upon one or more corresponding first scattered particle sources, and computing a secondary dose from said scattered particle fluence; and
instruction code means for computing a total dose for the first volume, the first volume commonly corresponding to a set of elements of the first grid and a set of elements of the second grid, wherein the total dose is a sum of primary doses derived for said set of elements of the first grid and secondary doses derived for said set of elements of the second grid.

58. The software program of claim 57, further comprising instruction code means for representing the brachytherapy source as a first number of point sources for grid elements located beyond a first distance from the brachytherapy source, and representing the brachytherapy source as a second number of point sources for grid elements located within said first distance.

59. The software program of claim 57, further comprising:
data code means representing respective configurations of a plurality of brachytherapy sources; and
instruction code means for selecting a configuration of the plurality of brachytherapy sources to be used in treatment based upon criteria for providing a desired dose to a patient target volume within the patient treatment volume, and for limiting dose at patient structures prescribed to be critical structures.
